(19) United States
(12) Patent Application Publication
(10) Pub. No.: US 2005/0228109 A1
(43) Pub. Date: Oct. 13, 2005

(54) Thermoplastic compositions with improved paint adhesion

(76) Inventors: Tapan Chandra, Bangalore (IN); Roshan Kumar Jha, Bangalore (IN); Ganesh Kannan, Bangalore (IN); Parnasree Maiti, Midnapore (IN); Nisha Preschilla, Bangalore (IN); Kishore Avadhanula V.S., Bangalore (IN)

Correspondence Address: CANTOR COLBURN, LLP, 55 GRIFFIN ROAD SOUTH, BLOOMFIELD, CT, 06002, US

(21) Appl. No.: 10/820,309

(22) Filed: Apr. 7, 2004

(51) Int. Cl. C08K 3/04

(52) U.S. Cl. 524/495

(57) ABSTRACT

A thermoplastic composition comprises a compatibilized poly(arylene ether)/polyamide composition and an adhesion promoter selected from the group consisting of alpha-beta unsaturated carboxylic acid copolymers, polymers with pendant epoxy groups and combinations of two or more of the foregoing.

### BACKGROUND OF THE INVENTION

This disclosure relates to thermoplastic compositions with improved paint adhesion.

Poly(arylene ether) resins are commercially attractive materials because of their unique combination of physical, chemical, and electrical properties. Furthermore, the combination of these resins with polyamide resins into compatibilized blends results in additional overall properties such as chemical resistance, high strength, and high flow.

The physical properties of poly(arylene ether)/polyamide blends make them attractive for a variety of end-use articles in the automotive market, especially for various painted exterior components. However, when these compositions are to be utilized in automotive applications it is generally desirable to improve their impact properties, especially when used as exterior automotive body panels, bumpers, and the like, by adding impact modifiers.

Some of the more desirable applications, for example, automotive fenders, require the molded plastic parts affixed to the automobile frame to go through high temperature ovens used to cure the anti-corrosion coating that has been applied to the metal panels. High temperature cures are especially important in the so-called “E-coating” process, in which an epoxy coating is applied to the metal parts and then cured prior to electrostatic painting. In electrostatic painting, a uniform coating of paint is established as the result of an electrical attraction between the part and charged paint particles. The ovens used for “E-coating” typically reach temperatures of about 165° C. to about 230° C. or higher for periods of 10 to 50 minutes or longer. These temperatures can cause low molecular weight ingredients or reaction products present in the poly(arylene ether)/polyamide compositions to migrate to the surface, leading to the formation of a film on the surface of the respective article. Such films are undesirable and often give rise to paint adhesion problems. The ability to withstand the time and temperature of the ovens without distortion limits the success of many plastic resins. Moreover, paint adhesion issues with plastic panels after passing through the ovens has also limited their acceptance. It is therefore apparent that a need continues to exist for improved thermoplastic compositions and method to improve paint adhesion on such compositions for painted automotive components.

### BRIEF DESCRIPTION OF THE INVENTION

The paint adhesion problems discussed above are addressed, at least in part, by a thermoplastic composition comprising a compatibilized poly(arylene ether)/polyamide composition and an adhesion promoter selected from the group consisting of alpha-beta unsaturated carboxylic acid copolymers, polymers with pendant epoxy groups and combinations of two or more of the foregoing.

### DETAILED DESCRIPTION

A thermoplastic composition having improved paint adhesion comprises compatibilized poly(arylene ether)/polyamide composition and an adhesion promoter selected from the group consisting of alpha-beta unsaturated carboxylic acid copolymers, polymers with pendant epoxy groups and combinations of two or more of the foregoing. The adhesion promoter may further comprise a polyester ionomer such as a polybutylene terephthalate or polyethylene terephthalate ionomer. The composition is made by melt mixing poly(arylene ether), a compatibilizer and polyamide to make a compatibilized poly(arylene ether)/polyamide composition and melt-mixing the compatibilized composition with the adhesion promoter. When the thermoplastic composition comprising an adhesion promoter is molded and painted and subjected to steam jet testing, as described below, the painted articles demonstrate a substantial decrease in the number of failed squares when compared to a comparable composition that does not contain the adhesion promoter. Additionally, the thermoplastic composition comprising an adhesion promoter improves paint adhesion while maintaining other important physical properties such as impact strength and melt viscosity.

The terms “a” and “an” herein do not denote a limitation of quantity, but rather denote the presence of at least one of the referenced item. All ranges disclosed herein are inclusive and combinable (e.g., ranges of “about X to about Y, or more specifically, about W to about Z” is inclusive of the endpoints and all intermediate values such as about X to about Z).

Poly(arylene ether)s are known polymers comprising a plurality of structural units of the formula (I): 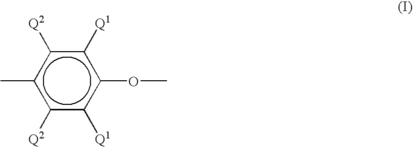
wherein for each structural unit, each Q¹ is independently hydrogen, halogen, primary or secondary lower alkyl (e.g., alkyl containing up to 7 carbon atoms), phenyl, haloalkyl, aminoalkyl, hydrocarbonoxy, halohydrocarbonoxy wherein at least two carbon atoms separate the halogen and oxygen atoms; and each Q2 is independently hydrogen, halogen, primary or secondary lower alkyl, phenyl, haloalkyl, hydrocarbonoxy, halohydrocarbonoxy wherein at least two carbon atoms separate the halogen and oxygen atoms. In one embodiment, each Q¹ is alkyl or phenyl, especially C₁₋₄ alkyl, and each Q² is hydrogen.

Both homopolymer and copolymer poly(arylene ether) may be included. The preferred homopolymers are those comprising 2,6-dimethyl-1,4-phenylene ether units. Suitable copolymers include random copolymers comprising such units in combination with (for example) 2,3,6-trimethyl-1,4-phenylene ether units. Also included are poly(arylene ether)s containing moieties prepared by grafting vinyl monomers or polymers such as polystyrenes and elastomers, as well as coupled poly(arylene ether)s in which coupling agents such as low molecular weight polycarbonates, quinones, heterocycles and formals undergo reaction in known manner with the hydroxy groups of two poly(arylene ether) chains to produce a higher molecular weight polymer. Poly(arylene ether)s further include combination of any of the above.

The poly(arylene ether) generally has a number average molecular weight of about 3,000-40,000 atomic mass units (amu) and a weight average molecular weight of about 20,000-80,000 amu, as determined by gel permeation chromatography. The poly(arylene ether) may have an intrinsic viscosity of about 0.10 to about 0.60 deciliters per gram (dl/g), or, more specifically, about 0.29 to about 0.48 dl/g, as measured in chloroform at 25° C. It is also possible to utilize a high intrinsic viscosity poly(arylene ether) and a low intrinsic viscosity poly(arylene ether) in combination. Determining an exact ratio, when two intrinsic viscosities are used, will depend somewhat on the exact intrinsic viscosities of the poly(arylene ether) used and the ultimate physical properties that are desired.

Poly(arylene ether) is generally prepared by the oxidative coupling of at least one monohydroxyaromatic compound such as 2,6-xylenol or 2,3,6-trimethylphenol. Catalyst systems are generally employed for such coupling; they generally contain at least one heavy metal compound such as a copper, manganese or cobalt compound, usually in combination with various other materials.

Particularly useful poly(arylene ether)s for many purposes are those which comprise molecules having at least one aminoalkyl-containing end group. The aminoalkyl radical is generally located in a position ortho to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, generally obtained from reaction mixtures in which a by-product diphenoquinone is present, especially in a copper-halide-secondary or tertiary amine system. A substantial proportion of the polymer molecules, generally comprising as much as about 90% by weight of the polymer, may contain at least one of said aminoalkyl-containing and 4-hydroxybiphenyl end groups.

It will be apparent to those skilled in the art from the foregoing that the poly(arylene ether)s include many of those presently known, irrespective of variations in structural units or ancillary chemical features.

The thermoplastic composition may comprise poly(arylene ether) in an amount of about 20 to about 50 weight percent, or, more specifically, in an amount of about 25 to about 45 weight percent, or, even more specifically, in an amount of about 30 to about 40 weight percent, wherein the weight percents are based on the total weight of the thermoplastic composition.

Polyamide resins are a generic family of resins known as nylons, characterized by the presence of an amide group(-CONH-). Exemplary polyamides include nylon-6, nylon-6,6, nylon-4,6, nylon-12, nylon-6,10, nylon-6,9, nylon-6/6T, nylon-6/6T, PA9T with triamine contents below about 0.5 weight percent, copolymers of the foregoing, and combinations of the foregoing. Nylon 6 and nylon 6,6 are available from a variety of commercial sources. In one embodiment the polyamide comprises nylon 6, nylon 6,6 or a combination thereof.

The polyamides can be obtained by a number of well known processes such as those described in U.S. Pat. Nos. 2,071,250; 2,071,251; 2,130,523; 2,130,948; 2,241,322; 2,312,966; and 2,512,606. Nylon-6, for example, is a polymerisation product of caprolactam. Nylon-6,6 is a condensation product of adipic acid and 1,6-diaminohexane. Likewise, nylon-4,6 is a condensation product of adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylyene diamine, di-( 4-aminophenyl)methane, di-(4-aminocyclohexyl)methane, 2,2-di-(4-aminophenyl) propane, 2,2-di-(4-aminocyclohexyl)propane, among others. Copolymers of caprolactams with diacids and diamines are also useful.

Polyamides having a viscosity of up to about 400 millilitres per gram(ml/g) may be used, or, more specifically, a viscosity of about 90 to about 350 ml/g, or, even more specifically, about 110 to about 240 ml/g, as measured in a 0.5 weight percent solution in 96 weight percent sulphuric acid in accordance with ISO 307.

The thermoplastic composition may comprise polyamide in an amount of about 30 to about 65 weight percent, or, more specifically, in an amount of about 35 to about 55 weight percent, or, even more specifically, in an amount of about 45 to about 50 weight percent, wherein the weight percents are based on the total weight of the thermoplastic composition.

Compatibilized compositions of poly(arylene ether)s and polyamides are generally manufactured via reactive compounding techniques wherein a compatibilizing agent is added to the composition. Without being limited by theory it is generally believed that the compatibilizing agent brings about a reaction between the poly(arylene ether) and the polyamide and that these reaction products improve the compatibility between the poly(arylene ether) and polyamide. When used herein, the expression “compatibilizing agent” refers to those polyfunctional compounds which interact with the poly(arylene ether), the polyamide, or, preferably, both. This interaction may be chemical (e.g. grafting) or physical (e.g. affecting the surface characteristics of the dispersed phases). In either case the resulting poly(arylene ether)/polyamide composition appears to exhibit improved compatibility, particularly as evidenced by enhanced ductility, impact strength, mold knit line strength and/or elongation. As used herein, the expression “compatibilized poly(arylene ether)/polyamide composition” refers to those compositions which have been physically or chemically compatibilized with an agent as discussed above, as well as those compositions which are physically compatible without such agents, as taught, for example, in U.S. Pat. No. 3,379,792.

Suitable compatibilizing agents include, for example, liquid diene polymers, epoxy compounds, oxidized polyolefin wax, quinones, organosilane compounds, polyfunctional compounds, and functionalized poly(arylene ether)s obtained by reacting one or more of the previously mentioned compatibilizing agents with poly(arylene ether). In one embodiment the compatibilizing agent comprises citric acid, fumaric acid, maleic acid, maleic anhydride, derivatives of the foregoing or a combination of two or more of the foregoing.

The compatibilizing agents may be used alone or in various combinations. Furthermore, they may be added directly to the melt mix or pre-reacted with either or both the poly(arylene ether) and polyamide, as well as with other resinous materials. With many of the foregoing compatibilizing agents, particularly the polyfunctional compounds, even greater improvement in compatibility is found where at least a portion of the compatibilizing agent is pre-reacted, either in the melt or in a solution of a suitable solvent, with all or a part of the poly(arylene ether). It is believed that such pre-reacting may cause the compatibilizing agent to react with the polymer and, consequently, functionalize the poly(arylene ether). For example, the poly(arylene ether) may be pre-reacted with maleic anhydride to form an anhydride functionalized poly(arylene ether) that has improved compatibility with the polyamide compared to a non-functionalized poly(arylene ether).

Where the compatibilizing agent is employed, the amount used will depend on the specific compatibilizing agent chosen and the specific polymeric system to which it is added. Such amounts may be readily determined by one of ordinary skill in the art. In one embodiment in which the compatibilizing agent is citric acid, or fumaric acid, a suitable amount is about 0.01 to about 10.0 weight percent, or, more specifically, about 0.1 to about 2.0 weight percent, or, even more specifically, about 0.3 to about 1.5 weight percent, based on the total weight of the thermoplastic composition.

The thermoplastic composition comprises adhesion promoter to improve the paint adhesion characteristics of the thermoplastic composition. Without being bound by theory it is believed that the adhesion promoter enhances the surface polarity of the thermoplastic composition and thereby enhances the paint adhesion of the thermoplastic composition. The adhesion promoter is selected from the group consisting of alpha-beta unsaturated carboxylic acid copolymers, polymers having pendant epoxy groups and combinations of two or more of the foregoing adhesion promoters. The adhesion promoter may further comprise a polyester ionomer.

Alpha-beta unsaturated carboxylic acid copolymers are copolymer produced by the polymerisation of an alpha-beta unsaturated carboxylic acid with one more monomers such as an alpha-olefin, alkenyl aromatic compound or a combination of alpha-olefin and alkenyl aromatic compound. The alpha-beta unsaturated carboxylic acid may have 3 to about 8 carbons. Exemplary alpha-beta unsaturated carboxylic acids include acrylic acid, methacrylic acid, ethacrylic acid, chloroacrylic acid, crotonic acid, maleic acid, fumaric acid, itaconic acid and combinations of two or more of the foregoing. The alpha olefins may have 2 to about 10 carbons. Exemplary alpha olefins include ethylene, propylene, butylene and two or more of the foregoing. The alkenyl aromatic compound has formula I 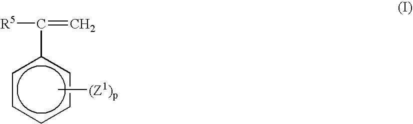
wherein R⁵ is hydrogen, lower alkyl or halogen; Z¹ is vinyl, halogen or lower alkyl; and p is 0 to 5. Exemplary alkenyl aromatic compounds include styrene. The alpha-beta unsaturated carboxylic acid copolymer has about 2 to about 30 weight percent repeating units derived from the alpha-beta unsaturated carboxylic acid or, more specifically about 2.5 to about 25 weight percent, or, even more specifically about 3 to about 21 weight percent, wherein the weight percents are based on the total weight of the alpha-beta unsaturated carboxylic acid copolymer. The alpha-beta unsaturated carboxylic acid copolymer may be in acidic form (COOH), salt form (COO⁻M⁺) or a combination of the two. M may be any positive ion that doesn't decrease the physical properties of the composition such as sodium, potassium or lithium.

In one embodiment the alpha-beta unsaturated carboxylic acid copolymer comprises ethylene-acrylic acid copolymer. Ethylene-acrylic acid copolymers are commercially available under the tradename PRIMACOR from Dow Chemicals, Escor from ExxonMobile and Nucrel from Dupont. In one embodiment, the alpha-beta unsaturated carboxylic acid copolymer is a styrene-acrylic acid copolymer. Styrene-acrylic acid copolymer is commercially available from Plasmine Corporation, and under the tradename VANCRYL from Airproducts Ltd.

Polymers with pendant epoxy groups comprise repeating subunits having formula (II): 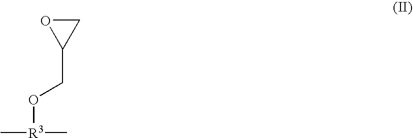
wherein R³ is a substituted or unsubstituted aromatic group having 6 to 9 carbons or alkyl group, branched, unbranched, or cyclic, substituted or unsubstituted, having 1 to 6 carbons. When R³ is substituted the substituent group is unreactive with the epoxy functionality. In one embodiment the polymer with pendant epoxy groups comprises repeating units of formula II wherein R³ is an aromatic group having 6 carbons.

The term polyester ionomer as used herein refers to the polycondensation reaction product of an aromatic dicarboxylic acid or its ester-forming derivative, a diol or its ester-forming derivative, and an ester-forming compound comprising an ionic sulfonate group.

The polyester ionomer may comprise a monovalent and/or divalent aryl carboxylic sulfonate salt units represented by the formula: 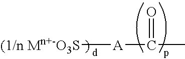
wherein p=1-3; d=1-3; p+d=2-6; M is a metal; n=1-5; and A is an aryl group containing one or more aromatic rings, for example, benzene, naphthalene, anthracene, biphenyl, terphenyl, oxy diphenyl, sulfonyl diphenyl, or alkyl diphenyl, where the sulfonate substituent is directly attached to an aryl ring. These groups are incorporated into the polyester through carboxylic ester linkages. The aryl groups may contain one or more sulfonate substituents (d=1-3) and may have one or more carboxylic acid linkages (p=1-3). Groups with one sulfonate substituent (d=1) and two carboxylic linkages (p=2) are preferred. Exemplary metals include alkali or alkaline earth metals where n=1-2, zinc and tin.

The polyester ionomer may alternatively comprise sulfonate salt units represented by the formula:
(1/n M^{n+ -}O₃Sd [symbol] _{d}A [symbol] OR″OH)ₚ
wherein p, d, M, n, and A are as defined above, and wherein R″ is a divalent alkylene or alkyleneoxy group, for example,
—CH₂CH₂—, —CH₂CH₂OCH₂CH₂—, —CH(CH₃)CH₂—, —CH₂CH₂CH₂—, —CH₂CH₂CH₂CH₂—,
and the like.

A preferred polyester ionomer comprises divalent ionomer units represented by the formula: 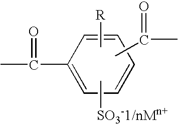
wherein R is hydrogen, halogen, alkyl having from one to about twenty carbons, or aryl having from one to about twenty carbons; M is a metal, and n=1-5.

Exemplary polyester ionomers include poly(ethylene terephthalate) (PET) ionomers, and poly(1,4-butylene terephthalate) (PBT) ionomers, and poly(1,3-propylene terephthalate) (PPT) ionomers.

Also contemplated herein are the above polyester ionomers with minor amounts, e.g., from about 0.5 to about 15 percent by weight, of units derived from aliphatic acid and/or aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539. Poly(1,4-butylene terephthalate) ionomer resin is obtained by polymerizing an ionomer component comprising a glycol component comprising at least 70 mole percent, preferably at least 90 mole percent, of tetramethylene glycol; and an acid component comprising about 1 to about 10 mole percent of a dimethyl 5-sodium sulfo-1,3-phenylenedicarboxylate, and at least 70 mole percent, preferably at least 90 mole percent, of terephthalic acid, and polyester-forming derivatives thereof.

The glycol component preferably comprises not more than 30 mole percent, or, more specifically, not more than 20 mole percent, of another glycol, such as ethylene glycol, trimethylene glycol, 2-methyl-1,3 -propane glycol, hexamethylene glycol, decamethylene glycol, cyclohexane dimethanol, or neopentylene glycol.

The acid component preferably comprises not more than 30 mole percent, or, more specifically, not more than 20 mole percent, of another acid such as isophthalic acid, 2,6-naphthalene dicarboxylic acid, 1,5-naphthalene dicarboxylic acid, 4,4′-diphenyldicarboxylic acid, 4,4′-diphenoxyethane dicarboxylic acid, p-hydroxy benzoic acid, sebacic acid, adipic acid and polyester-forming derivatives thereof.

It is also possible to use a branched polyester ionomer comprising a branching agent, for example, a glycol having three or more hydroxyl groups or an aromatic carboxylic acid having three or more carboxylic acid groups. Furthermore, it is sometimes desirable to have various concentrations of acid and hydroxyl end groups on the polyester, depending on the ultimate end-use of the composition.

Preferred polyester ionomers will possess sufficient thermal stability to withstand compounding temperatures of at least about 250° C., or, more specifically, at least about 275° C., or, even more specifically, at least about 300° C.

The thermoplastic composition comprises the adhesion promoter or combination of adhesion promoters in an amount sufficient to improve paint adhesion as determined by steam jet testing when compared to a comparable composition not containing an adhesion promoter, typically in an amount up to about 10 weight percent, or, more specifically in an amount of about 0.1 to about 5.0 weight percent, or, even more specifically in an amount of about 0.5 to about 2.5 weight percent, wherein the weight percents are based on the total weight of the thermoplastic composition.

The thermoplastic composition may further comprise an antioxidant, also known as a stabilizer, or a mixture of stabilizers effective to further enhance the paint adhesion characteristics of the thermoplastic composition, wherein the antioxidant is selected from the group consisting of the phenolic antioxidants, 3-arylbenzofuranones, the hindered amine stabilizers, ultraviolet light absorbers, alkaline metal salts of fatty acids, hydrotalcites, epoxydized soybean oils, hydroxylamines, tertiary amine oxides, thiosynergists, and mixtures of two or more of the foregoing antioxidants.

It is often desirable to add a metal salt to the thermoplastic composition to provide effective stabilization to the thermoplastic composition. Such salts are generally known in the art as exemplified in U.S. Pat. No. 4,857,575 to van der Meer et al. and may be represented by the general formula:
M^{+y}(X^{-z})ₙ
where M represents a metal ion such as copper, nickel, tin, cerium etc. X represents a negatively charged ion, preferably a halide such as Cl, Br, F, I; or a carboxylate such as stearate or acetate; n represents an integer of 1 to about 6, y is an integer representing the positive ionic charge of the metal ion whereas z is an integer representing the negative ionic charge of X.

Among the suitable metal salts suitable for use in the thermoplastic composition are CuCl₂, CuI, copper acetate and cerium stearate, all of which are commercially available from a variety of sources. Of these, CuI is preferred and is often used in combination with an additional halide source, e.g., KI. CuT may be obtained commercially or may be prepared by precipitation and isolation of the salt by reaction of copper metal and HI.

The metal salt will be utilized in amounts necessary to provide effective stabilization. Ordinarily at least about 0.001 parts by weight of the metal salt will be necessary per 100 parts by weight of the combined weight of poly(arylene ether) and polyamide. More than about 0.5 parts metal salt per 100 parts poly(arylene ether)-polyamide resin will not typically afford sufficient additional benefit to justify its use at such levels. It has been found that metal salts were effective at levels as low as 200 ppm for stabilization of the thermoplastic composition. It is also possible to provide in situ generation of a metal salt by utilizing a metal carboxylate such as cerium stearate in the presence of a counter ion source such as KI.

The thermoplastic composition may further comprise various impact modifiers for improving the impact strength. Useful elastomers include, for example, styrenic block copolymers and various acid functionalized ethylene-propylene copolymers (e.g., EP-graft-maleic anhydride). Especially preferred are the elastomeric block copolymers, for example, A-B-A triblock copolymers and A-B diblock copolymers. The A-B and A-B-A type block copolymer rubber additives, which may be used are thermoplastic rubbers comprised of one or two alkenyl aromatic blocks which are generally styrene blocks and a rubber block, e.g., a butadiene block, which may be partially or totally hydrogenated. Mixtures of these triblock copolymers and diblock copolymers having hydrogenated rubber blocks are especially preferred in the thermoplastic compositions of the disclosure.

Suitable A-B and A-B-A type block copolymers are disclosed in, for example, U.S. Pat. Nos. 3,078,254, 3,402,159, 3,297,793, 3,265,765, and 3,594,452 and U.K. Patent 1,264,741. Examples of typical species of A-B and A-B-A block copolymers include polystyrene-polybutadiene (SBR), polystyrene-poly(ethylene-propylene), polystyrene-polyisoprene, poly(alpha-methylstyrene)-polybutadiene, polystyrene-polybutadiene-polystyrene(SBR), polystyrene-poly(ethylene-butylene)-polystyrene (SEBS), polystyrene-polyisoprene-polystyrene and poly(.alpha.-methylstyrene)-polybutadiene-poly(.alpha.-methylstyrene), as well as the selectively hydrogenated versions thereof. In one embodiment the impact modifiers are combinations of polystyrene-poly(ethylene-butylene)-polystyrene and polystyrene-poly(ethylene-propylene) (SEP) copolymers.

Such A-B and A-B-A block copolymers are available commercially from a number of sources, including Phillips Petroleum under the trademark SOLPRENE, Shell Chemical Co., under the trademark KRATON, Dexco under the tradename VECTOR, and Kuraray under the trademark SEPTON.

Other useful impact modifiers include functionalized elastomeric polyolefins containing at least one moiety selected from the group consisting of anhydride, epoxy, oxazoline, orthoester and combinations of two or more of the foregoing moieties. The structural units of the elastomeric polyolefin are derived from ethylene and at least one C₃₋₈ olefin, such as, propylene, 1-butene, 1-hexene, and 1-octene.

The thermoplastic composition may comprise an impact modifier in an amount of about 1.0 to about 25.0 weight percent, or, more specifically, in an amount of about 3.0 to about 20.0 weight percent, or, even more specifically, in an amount of about 6.0 to about 15.0 weight percent, wherein the weight percents are based on the total weight of the thermoplastic composition.

The thermoplastic composition optionally comprises an electrically conductive filler. The conductive filler may be any filler that enhances the conductivity of the thermoplastic composition. Suitable conductive fillers may be fibrous, disc-shaped, spherical or amorphous and include, for example, conductive carbon black(CCB); conductive carbon fibers, including milled fibers; conductive vapor grown carbon fibers, carbon nanotubes and various mixtures thereof. Various types of conductive carbon fibers are known in the art, and may be classified according to their diameter, morphology, and degree of graphitization (morphology and degree of graphitization being interrelated). These characteristics are presently determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch. These types of fibers have a relatively lower degree of graphitization.

Small carbon fibers having diameters from about 3 to about 2000 nanometers, and “tree-ring” or “fishbone” structures are may be grown from hydrocarbons in the vapor phase, in the presence of particulate metal catalysts at moderate temperatures, i.e., about 800 to about 1500° C. Small carbon fibers are generally cylindrical, and have a hollow core. In the “tree-ring” structure a multiplicity of substantially graphitic sheets is coaxially arranged about the core, wherein the c-axis of each sheets is substantially perpendicular to the axis of the core. The interlayer correlation is generally low. In the “fishbone” structure, the fibers are characterized by graphite layers extending from the axis of the hollow core, as shown in EP 198 558 to Geus. A quantity of pyrolytically deposited carbon may also be present on the exterior of the fiber.

Exemplary small carbon fibers include graphitic or partially graphitic carbon fibers having diameters of about 3.5 to about 500 nanometers, with diameters of about 3.5 to about 70 nanometers being preferred, and diameters of about 3.5 to about 50 nanometers being more preferred. Representative carbon fibers are the vapor grown carbon fibers described in, for example, U.S. Pat. Nos. 4,565,684 and 5,024,818 to Tibbetts et al.; U.S. Pat. No. 4,572,813 to Arakawa; U.S. Pat. Nos. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and U.S. Pat. No. 5,591,382 to Nahass et al.

Carbon nanotubes, in contrast, are produced by laser-evaporation of graphite or carbon arc synthesis, yielding fullerene-related structures which consist of graphene cylinders which may be open, or closed at either end with caps containing pentagonal and/or hexagonal rings. Nanotubes may consist of a single wall or have multiple concentrically arranged walls, and have diameters of about 0.7 and about 2.4 nanometers for the single-wall nanotubes and about 2 to about 50 nanometers (nm) for the multi-wall nanotubes. In the multi-layer structure the cross-section of the hollow core becomes increasingly small with increasing numbers of layers. At diameters larger than about 10 to about 20 nanometers, multi-wall nanotubes begin to exhibit a hexagonal pillar shape, such that the curvature of the nanotubes becomes concentrated at the corners of the pillars. This arises from the interlayer correlation becoming established over a larger area with a structure close to that of graphite. This faceting is not found in the vapor-grown small carbon fibers described above, although it is possible to produce nanotubes from the vapor phase using much lower hydrocarbon pressures, and although the innermost tubes of some vapor grown carbon fibers are considered to be carbon nanotubes.

Nanotubes may consist of a single wall wherein the tube diameter is about 0.7 to about 2.4 nm or have multiple concentrically arranged walls wherein the tube diameter is from about 2 to about 50 nm. When nanotubes are used it is useful to have an average aspect ratio greater than or equal to about 5, or, more specifically, greater than about 100, or, even more specifically, greater than 1000. Representative carbon nanotubes are described in U.S. Pat. No. 6,183,714 to Smalley et al, U.S. Pat. No. 5,591,312 to Smalley, U.S. Pat. No. 5,641,466 to Ebbesen et al, U.S. Pat. No. 5,830,326 to Iijima et al, U.S. Pat. No. 5,951,832 to Tanaka et al, U.S. Pat. No. 5,919,429 to Tanaka et al.

Suitable conductive carbon blacks may be any conductive carbon black that is used in modifying the electrical conductivity of thermoplastic compositions. Such carbon blacks are sold under a variety of trade names, including but not limited to S.C.F. (Super Conductive Furnace), E.C.F. (Electric Conductive Furnace), Ketjen Black EC (available from Akzo Co., Ltd.) or acetylene black. In one embodiment the carbon black has an average particle size less than about 200 nm, or, more specifically, less than about 100 nm, or, even more specifically, less than about 50 nm. The conductive carbon black may also have surface areas greater than about 200 square meter per gram (m²/g), or, more specifically, greater than about 400 m²/g, or, even more specifically, greater than about 1000 m²/g. The conductive carbon blacks may have a pore volume (dibutyl phthalate absorption) greater than about 40 cubic centimeters per hundred grams (cm³/100 g), or, more specifically, greater than about 100 cm³/100 g, or, even more specifically, greater than about 150 cm³/100 g. Conductive carbon blacks may be utilized in amounts of about 0.5 to about 25 weight percent (wt %) based on the total weight of the composition.

In one embodiment, the conductive filler may be added to the composition in an amount that will result in the composition having a specific volume resistivity less than or equal to about 150 kiloOhm-centimetre(kOhm-cm), or, more specifically, less than or equal to about 90 kOhm-cm, or, even more specifically, less than or equal to about 50 kOhm-cm. When the specific volume resistivity is less than or equal to about 10 kOhm-cm, the thermoplastic composition is sufficiently conductive to allow electrostatic painting on articles made from the thermoplastic composition of the disclosure. The amount of the conductive filler to be added does vary depending on a number of factors such as the type of conductive filler and the ratio of poly(arylene ether) to polyamide and the degree of dispersion of the conductive filler.

The thermoplastic composition may comprise conductive filler in an amount of about 0.1 to about 15.0 weight percent, or, more specifically, in an amount of about 0.4 to about 10.0 weight percent, or, even more specifically, in an amount of about 0.7 to about 5.0 weight percent, wherein the weight percents are based on the total weight of the thermoplastic composition. In one embodiment, conductive carbon black is used as the conductive filler and may be added to the thermoplastic composition in an amount of about 0.1 to about 10.0 weight percent, or, more specifically, in an amount of about 0.8 to about 6.0 weight percent, or, even more specifically, in an amount of about 1.0 to about 5.0 weight percent, wherein the weight percents are based on the total weight of the thermoplastic composition.

The thermoplastic composition may also include effective amounts of at least one additive selected from the group consisting of flame retardants, drip retardants, dyes, pigments, colorants, stabilizers, small particle mineral such as clay, mica, and talc, antistatic agents, plasticizers, lubricants, and mixtures thereof. These additives are known in the art, as are their effective levels and methods of incorporation. Effective amounts of the additives vary widely, but they are usually present in an amount up to about 50% or more by weight, based on the weight of the entire composition. Especially preferred additives include hindered phenols, thio compounds and amides derived from various fatty acids. The preferred amounts of these additives generally ranges up to about 2% total combined weight based on the total weight of the composition.

The preparation of the thermoplastic composition is generally achieved by melt mixing the components under conditions favourable for the formation of an intimate composition. Such conditions often include mixing in single or twin screw type extruders, roll mills, buss kneaders, or similar mixing devices that can apply a shear to the ingredients.

All the components may be added initially to the processing system, or else certain additives may be pre-compounded with one or more of the primary components, preferably the poly(arylene ether), the impact modifiers and the polyamide. The components may be added simultaneously or sequentially. It appears that certain properties, such as impact strength and elongation, may be enhanced by initially precompounding the poly(arylene ether), compatibilizing agent, impact modifiers, optionally with any other components, prior to compounding with the polyamide. Also certain physical properties are improved if the adhesion promoter is added downstream of the polyamide addition.

While separate extruders may be used in the processing, in one embodiment the compositions is prepared by using a single extruder having multiple feed ports along its length to accommodate the addition of various components. It may be advantageous to apply a vacuum to the melt through one or more vent ports in the extruder to remove the volatile impurities in the composition. Those of ordinary skill in the art will be able to adjust the melt mixing times and temperature, as well as component addition, without undue additional experimentation.

In one embodiment, a process for producing the thermoplastic composition comprises introducing a poly(arylene ether), a compatibilizing agent, an optional impact modifier and an optional antioxidant to a first feed port of an extruder and melt mixing the introduced components at a temperature of about 270 to about 320° C. to form a first blend. A minor portion of a polyamide may also be added at the first feed port. The process further comprises introducing a polyamide to a second feed port of the extruder and melt mixing the first blend with the polyamide at a temperature of about 270 to about 320° C. to form a second blend, wherein the second feed port is downstream of the first feed port. The process further comprises introducing a conductive filler and an adhesion promoter to a third feed port of an extruder and melt mixing the second blend with the conductive filler and the adhesion promoter at a temperature of about 270 to about 320° C. to form the thermoplastic composition, wherein the third feed port is downstream of the second feed port.

In another embodiment, a process for producing the thermoplastic composition comprises introducing a poly(arylene ether), a compatibilizing agent, an optional impact modifier and an optional antioxidant to a first feed port of an extruder and melt mixing the introduced components at a temperature of about 270 to about 320° C. to form a first blend. A minor portion of a polyamide may also be added at the first feed port. The process further comprises introducing a polyamide to a second feed port of the extruder and melt mixing the first blend with the polyamide at a temperature of about 270 to about 320° C. to form a second blend, wherein the second feed port is downstream of the first feed port. The process further comprises introducing a conductive filler to a third feed port of an extruder and melt mixing the second blend with the conductive filler at a temperature of about 270 to about 320° C. to form the thermoplastic composition, wherein the third feed port is downstream of the second feed port. The resulting thermoplastic composition, either before or after pelletization, may then be melt mixed with the adhesion promoter.

The thermoplastic composition of the disclosure may be processed by various techniques including injection molding, blow molding, sheet extrusion, film extrusion, profile extrusion, pultrusion, compression molding, thermoforming, pressure forming, hydroforming, vacuum forming, and foam molding.

The disclosure is further illustrated by the following non-limiting examples, illustrating compositions and methods of producing some of the various embodiments of the thermoplastic compositions.

### EXAMPLES 1-7

These examples describe the formulation and testing of thermoplastic compositions comprising adhesion promoters.

The components used in the Examples are shown in Table 1.

TABLE 1

| Component | Description and Supplier |
|---|---|
| Poly(arylene ether) (PPE) | Poly(2,6-dimethylphenylene ether) was |
| | obtained from GE Advanced Materials, |
| | Plastics and had a weight average |
| | molecular weight (Mw) of about 44,000 |
| | and an intrinsic viscosity of about 0.4 |
| | deciliters per gram (dl/g) measured in |
| | chloroform at 25° C. |
| Polyamide 1 (PA1) | Nylon 6 available as Technyl |
| | ASN27/32-35 lc from Rhodia |
| Polyamide 2 (PA2) | Nylon 6, 6 available from Rhodia having |
| | weight average molecular weight (Mw) |
| | of 69,000 and a viscosity number ISO |
| | 307 (Vz) of 126 ml/g. |
| Citric Acid | Available from SD Fine Chem Ltd. |
| Ethylene-acrylic acid | Primacor, available from Dow |
| copolymer | Chemicals Ltd. |
| Styrene-acrylic acid | Vancryl available from Airproducts Ltd. |
| copolymer | |
| Adhesion promoter with | Epoxy-cresol-novolac (ECN) available |
| pendant epoxy groups | from RTP Co. |
| Polybutylene terephthalate | Available from GE Advanced |
| ionomer (PBT) | Materials, Plastics as 20% PBT |
| | Ionomer |
| Anti oxidant (AO) | IRGANOX 1076 available from Ciba- |
| | Geigy |
| Potassium Iodide (KI) | Used as a 50 weight percent solution in |
| | water. |
| Cuprous iodide (CuI) | Available from SD Fine Chem Ltd. |
| Conductive carbon black | Available as Ketjen Black EC from |
| (CCB) | Akzo Nobel, Netherlands. |
| Polystyrene-poly(ethylene | Available as KRATON ® G1651E from |
| butylene)-Polystyrene block | Shell Nederland BV and had a Mw of |
| copolymer (SEBS) | 267,500. |
| Polystyrene-poly(ethylene | Available as KRATON ® G1701E from |
| propylene) block copolymer | Shell Nederland BV and had an Mw of |
| (SEP) | 152400. |

The compositions were made by first melt mixing the poly(arylene ether), impact modifiers, antioxidant and compatibilizer. Polyamide was then added and melt mixed. Conductive carbon black and adhesion promoter were then added and melt mixed. The composition was injection molded for testing. Notched Izod was measured at 23° C. and at −20° C. according to ISO 180/1A. Values shown are in kilojoules per square meter (kJ/m²). Vicat-B softening temperature was measured according to ISO 306 and values are in degrees centigrade (° C.). Specific volume resistivity (SVR) was determined by as follows. A tensile bar was molded according to ISO 3167. A sharp, shallow cut was made near each end of the narrow central portion of the bar. The bar was fractured in a brittle fashion at each cut to separate the narrow central portion, now having fractured ends with dimensions of about 10×4 millimeters. If necessary to obtain fracturing in a brittle fashion, the tensile bar was first cooled, for example, in dry ice or liquid nitrogen in a −40 ° C. freezer. The length of the bar between the fractured ends was measured. The fractured ends of the sample were painted with conductive silver paint, and the paint was allowed to dry. Using a multi-meter in resistance mode, electrodes were attached to each of the painted surfaces, and the resistance was measured at an applied voltage of 500-1000 millivolts. Values of the specific volume resistivity were obtained by multiplying the measured resistance by the fracture area of one side of the bar and dividing by the length: p=R×A/L where p is the specific volume resistivity in ohm-cm, R is the measured resistance in Ohms, A is the fractured area in square centimeters (cm²), and L is the sample length in centimeters (cm). The specific volume resistivity values thus have units of kiloOhm.cm.

The paint adhesion of the thermoplastic composition was evaluated by performing a steam jet test which was conducted as follows. A 10 cm diameter disk or a larger part such as a fender was spray painted with a paint system comprising Sandouville primer 50062 or 50058, Flins basecoat 71432 “base Blue de methyl”, and Flins clearcoat 81038H to give a paint layer having a thickness approximately 40 to 80 micrometers thick. In the center of the painted disk, a sharp knife was used to cut a cross in the center of the painted surface, extending through the paint layer into the molded plastic layer. A steam jet of hot water at a temperature of 80° C. and a pressure of 105 bar was sprayed at the center of the cross from a distance of 10 centimeter for 60 seconds. Paint adhesion failures generally occurred, if at all, first at the intersection of the cross, and paint flaked off from that point. The area from which paint was removed was assessed by overlaying a grid of 2 millimeter (mm) by 2 mm squares on the top of the disk and counting the number of squares from which at least some paint has been visibly removed. Total failure of the paint adhesion would have corresponded to 392 failed squares.

Compositions and test results are given in Table 2. Amounts of the components are given in weight percent based on the total weight of the composition.

TABLE 2

| Composition | 1* | 2 | 3 | 4 | 5 | 6 | 7 |
|---|---|---|---|---|---|---|---|
| SEP | 8.00 | 5.00 | 3.00 | 6.42 | 3.00 | 3.00 | 9.00 |
| SEBS | 7.00 | 3.00 | 5.10 | 7.17 | 5.00 | 9.00 | 6.00 |
| Citric Acid | 0.7 | 0.7 | 0.7 | 0.6 | 0.3 | 0.3 | 0.7 |
| PPE | 34.10 | 36.38 | 36.76 | 34.22 | 36.55 | 35.10 | 33.48 |
| PA1 | 10 | 10.67 | 10.78 | 10.04 | 10.72 | 10.29 | 9.82 |
| PA2 | 38 | 40.55 | 40.96 | 38.13 | 40.73 | 39.11 | 37.31 |
| Adhesion | — | ECN | Primacor | Primacor | Vancryl | Vancryl | Primacor |
| promoter 1 | | | 5990I | 5990I | 68 | 68 | 5990I |
| Adhesion | 0.0 | 0.5 | 0.5 | 1.18 | 0.5 | 0.5 | 1.5 |
| promoter 1 | | | | | | | |
| amount | | | | | | | |
| Adhesion | — | PBT | Vancryl | Primacor | Primacor | PBT | ECN |
| promoter 2 | | ionomer | 68 | 5990I | 5990I | ionomer | |
| Adhesion | 0.0 | 1.0 | 0.0 | 0.03 | 1.0 | 0.5 | 0.0 |
| promoter 2 | | | | | | | |
| amount | | | | | | | |
| AO | 0.3 | 0.3 | 0.3 | 0.3 | 0.3 | 0.3 | 0.3 |
| KI | 0.1 | 0.1 | 0.1 | 0.1 | 0.1 | 0.1 | 0.1 |
| CuI | 0.01 | 0.01 | 0.01 | 0.01 | 0.01 | 0.01 | 0.01 |
| CCB | 1.8 | 1.8 | 1.8 | 1.8 | 1.8 | 1.8 | 1.8 |
| SVR | 18.7 | 5.2 | 23.4 | 129.04 | 20.4 | 8.8 | 8.8 |
| (kOhm · cm) | | | | | | | |
| NI at 23° C. | 24.61 | 17.92 | 17.01 | 18.78 | 16.07 | 20.07 | 29.42 |
| (kJ/m2) | | | | | | | |
| NI at −20° C. | 15.76 | 12.03 | 10.14 | 11.48 | 11.40 | 13.12 | 16.16 |
| (kJ/m2) | | | | | | | |
| VST (° C.) | 174.80 | 190.35 | 192.95 | 181.65 | 198.65 | 184.6 | 179.85 |
| Failed Squares | 13 | 5 | 5 | 4 | 2 | 2 | 0 |
| in steam jet | | | | | | | |

*Comparative Example

The test data show a significant increase in paint adhesion (a decrease in the number of failed squares) for all the formulations (2-7) comprising adhesion promoter as compared to the comparative example (1).

### EXAMPLES 8-14

These examples employed the same materials as in Examples 1-7 and demonstrate improved paint adhesion for articles molded from the thermoplastic compositions by performing a peel test. The peel test is used to measure the paint adhesion of the thermoplastic composition by calculating the peel strength in Newtons (N) required to peel off the paint layer from the substrate of the article with the help of a force gauge. The peeling strip is glued onto the substrate with a cynoacrylate based adhesive with the tradename of Superglue. A minimum of one hour time is allowed for adhesive to dry before the test is started. The higher the peel strength, the greater the paint adhesion. A comparative example (8) having the same composition as Example 1 was prepared and tested for peel strength as well as Vicat softening temperature, specific volume resistivity, and Notched Izod as described above. Examples 10-17 had adhesion promoters of the types and amounts shown in Table 3. Weight percent is shown as wt %.

TABLE 3

| | Adhesion | | | Impact | Peel |
|---|---|---|---|---|---|
| | promoter and | VST | SVR | Strength | Strength |
| Example | amount | (° C.) | (kOhm · cm) | (kJ/m2) | (N) |
| 8* | None | 181.35 | 10.12 | 22.33 | 41.3 |
| 9 | 1 wt % Vancryl | 180.30 | 69.18 | 22.43 | 52.5 |
| | 68 | | | | |
| 10 | 1 wt % Primacor | 172.26 | 7.43 | 18.19 | 44.6 |
| | 5990I | | | | |
| 11 | 1 wt % ECN | 180.80 | 9.90 | 22.63 | 51.1 |
| 12 | 3 wt % Vancryl | 169.00 | 2933 | 10.73 | 6.0 |
| | 68 | | | | |
| 13 | 3 wt % Primacor | 175.23 | 0.29 | 8.05 | 10.0 |
| | 5990I | | | | |
| 14 | 3 wt % ECN | 183.00 | >10⁸ | 22.81 | 15.1 |

The test data show an increase in peel strength on addition of ethylene-acrylic acid copolymer, styrene-acrylic acid copolymer, or a polymer having pendant epoxy groups in an amount about 1 weight percent and thereby resulting in improved paint adhesion. Paint adhesion is improved over a wide range of paint systems and painting methods including in-line, on-line and off-line.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A thermoplastic composition comprising:
a compatibilized poly(arylene ether)/polyamide composition; and
an adhesion promoter selected from the group consisting of alpha-beta unsaturated carboxylic acid copolymers, polymers with pendant epoxy groups and combinations of two or more of the foregoing.

2. The thermoplastic composition of claim 1, wherein the composition further comprises electrically conductive filler.

3. The thermoplastic composition of claim 2, wherein the electrically conductive filler comprises conductive carbon black.

4. The thermoplastic composition of claim 1, wherein the polyamide is selected from the group consisting of nylon-6, nylon-6,6, nylon-4,6, nylon-12, nylon 6,9, nylon 6/6T, PA9T, and combinations of two or more of the foregoing polyamides.

5. The thermoplastic composition of claim 1, wherein the adhesion promoter further comprises a polyester ionomer.

6. The thermoplastic composition of claim 1, further comprising an impact modifier.

7. The thermoplastic composition of claim 6, wherein the impact modifier is selected from the group consisting of polystyrene-polybutadiene, polystyrene-polyisoprene, poly(alpha-methyl styrene)-polybutadiene, polystyrene-polybutadiene-polystyrene, polystyrene-polyisoprene-polystyrene, polystyrene-poly(ethylene-butylene)-polystyrene triblock copolymer, polystyrene-poly(ethylene-propylene) diblock copolymer, poly(alpha-methylstyrene)-polybutadiene-poly(alpha-methylstyrene) and combinations of two or more of the foregoing impact modifiers.

8. The thermoplastic composition of claim 1, further comprising an antioxidant.

9. The thermoplastic composition of claim 8, wherein the antioxidant is selected from the group consisting of phenolic antioxidants, 3-arylbenzofuranones, the hindered amine stabilizers, ultraviolet light absorbers, alkaline metal salts of fatty acids, hydrotalcites, epoxydized soybean oils, hydroxylamines, tertiary amine oxides, thiosynergists, and mixtures of two or more of the foregoing antioxidants

10. The thermoplastic composition of claim 1, further comprising a metal salt.

11. The thermoplastic composition of claim 1, wherein the poly(arylene ether) is present in an amount of about 20 to about 50 weight percent, based on the total weight of the thermoplastic composition, the polyamide is present in an amount of about 30 to about 65 weight percent, based on the total weight of the thermoplastic composition, and the adhesion promoter is present in an amount sufficient to improve paint adhesion when compared to a comparable composition not containing the adhesion promoter.

12. A molded article comprising the thermoplastic composition of claim 1.

13. A thermoplastic composition comprising:
a compatibilized poly(arylene ether)/polyamide composition comprising about 20 to about 50 weight percent poly(arylene ether) and about 30 to about 65 weight percent polyamide, based on the total weight of the thermoplastic composition;
about 1 to about 25 weight percent of an impact modifier, based on the total weight of the thermoplastic composition;
about 0.1 to about 15 weight percent of an electrically conductive filler, based on the total weight of the thermoplastic composition; and
about 0.1 to about 5 weight percent of an adhesion promoter selected from the group consisting of acrylic acid copolymers and polymers with pendant epoxy groups, and combinations of the foregoing wherein all weight percents are based on the total weight of the composition.

14. A thermoplastic composition, produced by a process comprising:
melt mixing a compatibilized poly(arylene ether) polyamide composition with an adhesion promoter selected from the group consisting of alpha-beta unsaturated carboxylic acid copolymers, polymers with pendant epoxy groups and combinations of two or more of the foregoing.

15. The thermoplastic composition of claim 14 wherein the compatibilized poly(arylene ether) polyamide composition further comprises an impact modifier.

16. The thermoplastic composition of claim 14 wherein the compatibilized poly(arylene ether) polyamide composition further comprises an anti-oxidant.

17. The thermoplastic composition of claim 14 further comprising a metal salt.

18. The thermoplastic composition of claim 14 wherein the compatibilized poly(arylene ether) polyamide composition further comprises an electrically conductive filler.

19. A molded part comprising the thermoplastic composition of claim 14.
